(19) United States
(12) Patent Application Publication
(10) Pub. No.: US 2007/0217190 A1
(43) Pub. Date: Sep. 20, 2007

(54) Light source array, backlight module and liquid crystal display using same

(75) Inventors: Kun-Hsien Yang, Miao-Li (TW); An Shih, Miao-Li (TW); Chien-Fan Tung, Miao-Li (TW); Li-Chun Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/725,743

(22) Filed: Mar. 19, 2007

(30) Foreign Application Priority Data
Mar. 17, 2006 (TW) 95109301

(51) Int. Cl. F21V 9/00

(52) U.S. Cl. 362/231

(57) ABSTRACT

An exemplary light source array (230) includes at least one light source bar (33), each light source bar comprising a plurality of light source unit (35), each light source unit (35) has a first color LED (351), two second color LEDs (353) and two third color LEDs (355). The two second color LEDs and two third color LEDs are respectively disposed at two sides of the first color LED, and two adjacent LEDs in each light source bar have two different colors.

### FIELD OF THE INVENTION

The present invention relates to a light source array typically used in a backlight module such as that of a liquid crystal display, and more particularly to a light source array, a backlight module and a liquid crystal display (LCD) having the light source array.

### GENERAL BACKGROUND

With the widespread use of liquid crystal display devices, such as in high-end portable electronic devices, mobile phones, and PDAs (Personal Digital Assistants), the demand for greater picture quality is ever present. In many liquid crystal display devices, a backlight module is needed for supplying light beams to support the display of images. Generally, a backlight module has two types: one is edge-side backlight module and the other is direct-type.

As shown in FIG. 8 and FIG. 9, a typical direct-type backlight module 1 includes a diffuser 12, a light source array 13 disposed at one side of the diffuser 12. The light source array 13 includes a plurality of light source bars 14, which has a plurality of light source units 16. Each light source unit 16 has a blue light emitting diode (LED) 161, two green LEDs 163 and two red LEDs 165. The blue LED 161 is disposed between the two green LEDs 163, and the blue and green LEDs 161, 163 are disposed between the two red LEDs 165. In two adjacent LED units 16, two red LEDs 165 are adjacent. In addition, the light source array 13 is strip type, i.e. each row of the light source array 13 has a same color LED.

However, in each light source bar 14, two adjacent red LED 165 are juxtaposed. Thus, the light source array 13 produces an uneven optical mixture. In addition, each row of the light source array 13 has a same color LED. So, optical mixture uniformity is further decreased.

What is needed, therefore, is a prism sheet and a prism sheet module that can overcome the above-described deficiencies.

### SUMMARY

An exemplary light source array includes at least one light source bar, each light source bar comprising a plurality of light source unit, each light source unit has a first color LED, two second color LEDs and two third color LEDs. The two second color LEDs and two third color LEDs are respectively disposed at two sides of the first color LED, and two adjacent LEDs in each light source bar have two different colors.

An exemplary backlight module includes a light guiding element, and a light source array. The light source array has at least one light source bar for providing luminance to the light guiding element. Each light source bar includes a plurality of light source unit, each light source unit has a first color LED, two second color LEDs and two third color LEDs. The two second color LEDs and two third color LEDs are respectively disposed at two sides of the first color LED, and two adjacent LEDs in each light source bar have two different colors.

An exemplary LCD includes a liquid crystal panel and a backlight module. The backlight module includes a light guiding element, and at least one light source bar for providing luminance to the light guiding element. The light source array includes at least one light source bar, each light source bar comprising a plurality of light source unit, each light source unit has a first color LED, two second color LEDs and two third color LEDs. The two second color LEDs and two third color LEDs are respectively disposed at two sides of the first color LED, and two adjacent LEDs in each light source bar have two different colors.

### BRIEF DESCRIPTION OF THE DRAWINGS

FIG. 1 is schematic view of a liquid crystal display (LCD) according to a first embodiment of the present invention, which has a backlight module.

FIG. 2 is a plane view of the backlight module of FIG. 1.

FIG. 3 is a plane view of a backlight module of an LCD according to a second embodiment of the present invention, which the backlight module has a light source bar.

FIG. 4 is a plane view of the light source bar of the backlight module of FIG. 3.

FIG. 5 is a plane view of a backlight module of an LCD according to a third embodiment of the present invention.

FIG. 6 is a plane view of a backlight module of an LCD according to a fourth embodiment of the present invention.

FIG. 7 is a plane view of a backlight module of an LCD according to a fifth embodiment of the present invention.

FIG. 8 is a plane view of a conventional backlight module and

FIG. 9 shows a light source bar of the backlight module of FIG. 8.

### DETAILED DESCRIPTION OF PREFERRED EMBODIMENTS

FIG. 1 shows a liquid crystal display (LCD) 200 according to a first embodiment of the present invention. The LCD 200 ha a liquid crystal panel 210 and a backlight module 230 at one side of the liquid crystal panel 210, for providing luminance to the liquid crystal panel 210.

The backlight module 230 includes a light guiding element 31 and a light source array (not labeled). The light guiding element 31 is light guide plate, which has a light incident surface 311, a light emitting surface 313 adjoining the light incident surface 311, and a bottom surface 315 opposite to the light emitting surface 313. The light source array is disposed adjacent to the light incident surface 311 of the light guiding element 31.

The light source array has a row of light source bar 33, which has a plurality of LEDs. The light source bar 33 has a first light source unit 35 and a second light source unit 37. The first light source unit 35 has a first color LED 351, two second color LEDs 353 and two third color LEDs 355. The first color LED 351 is disposed between the two second color LEDs 353, and the first and the second color LEDs 351, 353 are disposed between the two third color LEDs 355. The second light source unit 37 has a first color LED 371, two second color LEDs 373 and two third color LEDs 375. The first color LED 371 is disposed between the two third color LEDs 375, and the first and the third color LEDs 371, 375 are disposed between the two second color LEDs 373. The first color LEDs 351, 371 are blue LEDs, the second color LEDs 353, 373 are red LEDs, and the third color LED 355, 375 are green LEDs.

In use, the first light source unit 35 and the second light source unit 37 of the light source bar 33 respectively have a first color LED, two second color LEDs and two third color LEDs. The blue LEDs 351, 371 are respectively disposed at a center region of the first light source unit 35 and the second light source unit 37, and no two same color LEDs are adjacent in the light source bar 33. Thus, the light source bar 33 can attain good white light beams having a uniform optical mixture characteristic.

In alternative embodiments, the second color LEDs 353, 373 can also be green LEDs, and the third color LEDs 355, 375 can be red LEDs.

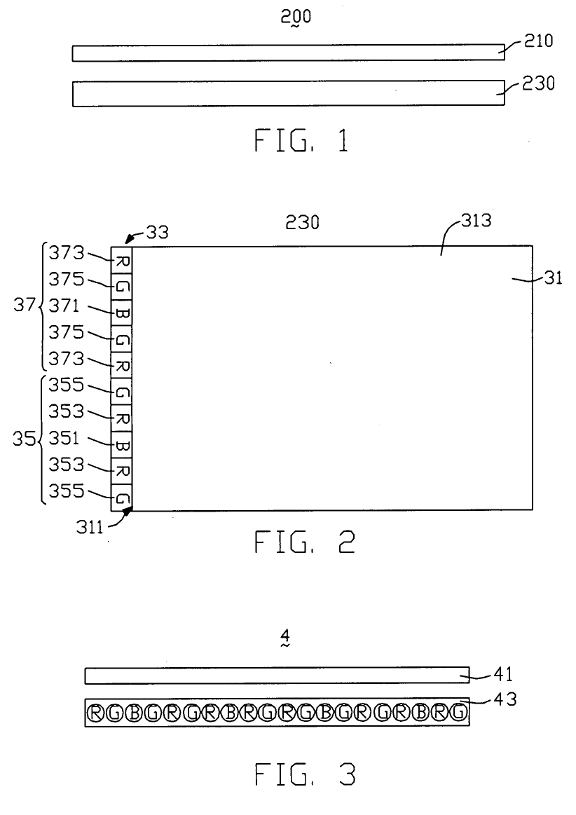

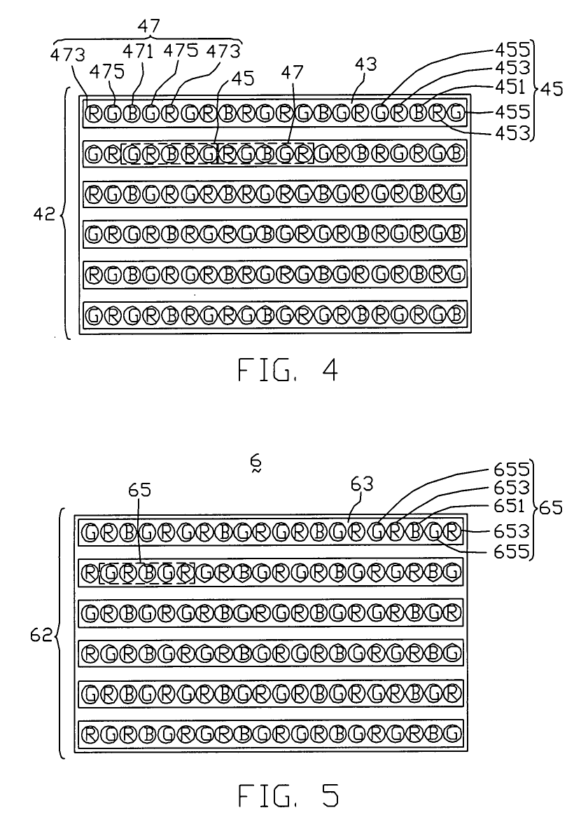

FIG. 3 and FIG. 4 disclose an alternative backlight module of a liquid crystal display according to a second embodiment of the present invention. The backlight module 4 includes a light guiding element 41 and a light source array (not labeled). The light guiding element 41 is diffuser.

The light source array has rows of light source bars 43, which has a plurality of LEDs. Each light source bar 43 has a plurality of first light source units 45 and a plurality of second light source units 47, alternately disposed. The first light source unit 45 has a first color LED 451, two second color LEDs 453 and two third color LEDs 455. The first color LED 451 is disposed between the two second color LEDs 453, and the first and the second color LEDs 451, 453 are disposed between the two third color LEDs 455. The second light source unit 47 has a first color LED 471, two second color LEDs 473 and two third color LEDs 475. The first color LED 371 is disposed between the two third color LEDs 475, and the first and the third color LEDs 471, 475 are disposed between the two second color LEDs 473. The first color LEDs 451, 471 are blue LEDs, the second color LEDs 453, 473 are red LEDs, and the third color LED 455, 475 are green LEDs. In the light source array 42, two adjacent light source bars 43 have different arrangement sequence, and two adjacent LEDs in one row of the light source array 42 have two different colors.

In use, the first light source unit 45 and the second light source unit 47 of the light source bar 43 respectively have a first color LED, two second color LEDs and two third color LEDs. The blue LEDs 451, 471 are respectively disposed at a center region of the first light source unit 45 and the second light source unit 47, and no two same color LEDs are adjacent in the light source bar 43, and two adjacent LEDs in one row of the light source array 42 have two different colors. Thus, the light source array 42 can attain good white light beams having a uniform optical mixture characteristic.

FIG. 5 discloses an another alternative backlight module of a liquid crystal display according to a third embodiment of the present invention. The backlight module 6 includes a light guiding element 61 and a light source array (not labeled). The light guiding element 61 is diffuser.

The light source array has rows of light source bars 63, which has a plurality of LEDs. Each light source bar 63 has a plurality of light source units 65. The first light source unit 65 has a first color LED 651, two second color LEDs 653 and two third color LEDs 655. The first color LED 651 is disposed a center region of the light source bar 63, and one second and one third color LEDs 653, 655 are respectively disposed at two opposite sides of the first color LED 651. Two adjacent LEDs of each light source bar has different colors. The first color LEDs 651 is blue LEDs, the second color LEDs 653 are red LEDs, and the third color LEDs 655 are green LEDs. In the light source array 62, two adjacent light source bars 63 have different arrangement sequence, and two adjacent LEDs in one row of the light source array 42 have two different colors.

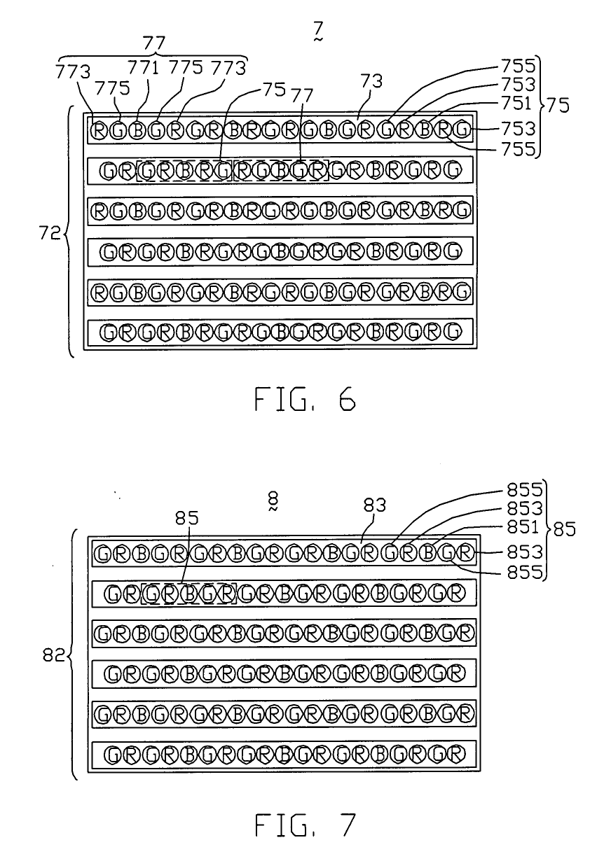

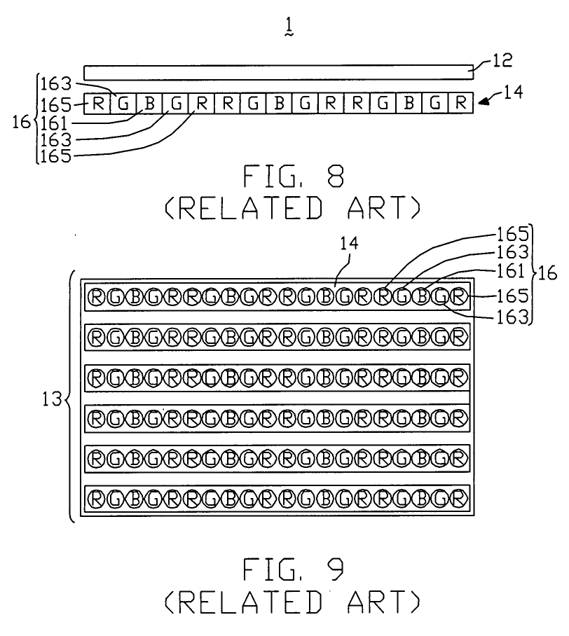

FIG. 6 discloses an another alternative backlight module of a liquid crystal display according to a fourth embodiment of the present invention. The backlight module 7 includes a light guiding element 71 and a light source array (not labeled). The light guiding element 71 is diffuser.

The light source array has rows of light source bars 73, which has a plurality of LEDs. Each light source bar 73 has a plurality of first light source units 75 and a plurality of second light source units 77, alternately disposed. The first light source unit 75 has a first color LED 751, two second color LEDs 753 and two third color LEDs 755. The first color LED 751 is disposed at a center region of the first light source unit 75, between two third color LESs 755, and the first and the third color LEDs 751, 755 are disposed between the two second color LEDs 753. The second light source unit 77 has a first color LED 771, two second color LEDs 773 and two third color LEDs 775. The first color LED 771 is disposed between the two second color LEDs 773, and the first and the second color LEDs 771, 773 are disposed between the third second color LEDs 775. The first color LEDs 751, 771 are blue LEDs, the second color LEDs 753, 773 are red LEDs, and the third color LED 755, 775 are green LEDs. In the light source array 72, two adjacent light source bars 73 have different arrangement sequence. In addition, LEDs in one row of the light source bar are respectively disposed a center region of two corresponding LEDs of the other two adjacent light source bars 73.

FIG. 7 discloses an another alternative backlight module of a liquid crystal display according to a third embodiment of the present invention. The backlight module 8 includes a light guiding element 81 and a light source array (not labeled). The light guiding element 81 is diffuser.

The light source array has rows of light source bars 83, which has a plurality of LEDs. Each light source bar 83 has a plurality of light source units 85. The first light source unit 85 has a first color LED 851, two second color LEDs 853 and two third color LEDs 855. The first color LED 851 is disposed a center region of the light source bar 83, and one second and one third color LEDs 853, 855 are respectively disposed at two opposite sides of the first color LED 851. Two adjacent LEDs of each light source bar has different colors. The first color LEDs 851 is blue LEDs, the second color LEDs 853 are red LEDs, and the third color LEDs 855 are green LEDs. In the light source array 82, two adjacent light source bars 83 have different arrangement sequence, and two adjacent LEDs in one row of the light source array 42 have two different colors. In addition, LEDs in one row of the light source bar 83 are respectively disposed a center region of two corresponding LEDs of the other two adjacent light source bars 83.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light source array, comprising:
at least one light source bar, each light source bar comprising a plurality of light source unit, each light source unit comprising a first color LED, two second color LEDs and two third color LEDs;
wherein the two second color LEDs and two third color LEDs are respectively disposed at two sides of the first color LED, and two adjacent LEDs in each light source bar have two different colors.

2. The light source array as claimed in claim 1, wherein the first color LED is a blue LED.

3. The light source array as claimed in claim 2, wherein the second color LED is a red LED.

4. The light source array as claimed in claim 3, wherein the third color LED is a green LED.

5. The light source array as claimed in claim 1, wherein the light source array has a plurality of light source bar, two adjacent LEDs in each row have two different colors.

6. The light source array as claimed in claim 5, wherein LEDs in one row of the light source bar are respectively disposed a center region of two corresponding LEDs of the other two adjacent light source bars.

7. The light source array as claimed in claim 1, wherein each light source bar has at least one first light source units and at least one second light source units.

8. The light source array as claimed in claim 7, wherein the two third color LEDs are respectively disposed at two opposite sides of the first color LED, in the first light source unit.

9. The light source array as claimed in claim 8, wherein the two second color LEDs are respectively disposed at two opposite sides of the first color LED, in the first light source unit.

10. The light source array as claimed in claim 1, wherein one second color LED and one third color LED are respectively disposed at two opposite sides of the first color LED.

11. A backlight module, comprising:
a light guiding element, and
a light source array for providing luminance to the light guiding element, which comprises at least one light source bar, each light source bar comprising a plurality of light source unit, each light source unit comprising a first color LED, two second color LEDs and two third color LEDs;
wherein the two second color LEDs and two third color LEDs are respectively disposed at two sides of the first color LED, and two adjacent LEDs in each light source bar have two different colors.

12. The backlight module as claimed in claim 11, wherein the first color LED is a blue LED.

13. The backlight module as claimed in claim 12, wherein the second color LED is a red LED.

14. The backlight module as claimed in claim 13, wherein the third color LED is a green LED.

15. The backlight module as claimed in claim 11, wherein the light source array has a plurality of light source bar, two adjacent LEDs in each row have two different colors.

16. The backlight module as claimed in claim 15, wherein LEDs in one row of the light source bar are respectively disposed a center region of two corresponding LEDs of the other two adjacent light source bars.

17. The backlight module as claimed in claim 11, wherein each light source bar has at least one first light source units and at least one second light source units.

18. The backlight module as claimed in claim 17, wherein the two third color LEDs are respectively disposed at two opposite sides of the first color LED, in the first light source unit.

19. The backlight module as claimed in claim 18, wherein the two second color LEDs are respectively disposed at two opposite sides of the first color LED, in the first light source unit.

20. A liquid crystal display, comprising:
a liquid crystal panel; and
a backlight module, comprising:
a light guiding element, and
a light source array for providing luminance to the light guiding element, which comprises at least one light source bar, each light source bar comprising a plurality of light source unit, each light source unit comprising a first color LED, two second color LEDs and two third color LEDs;
wherein the two second color LEDs and two third color LEDs are respectively disposed at two sides of the first color LED, and two adjacent LEDs in each light source bar have two different colors.
